(19) United States
(12) Patent Application Publication
(10) Pub. No.: US 2007/0188600 A1
(43) Pub. Date: Aug. 16, 2007

(54) Multi-stage media compression technique for power and storage efficiency

(76) Inventors: Jeffrey Allen Cooper, Rocky Hill, NJ (US); Kumar Ramaswamy, Princeton, NJ (US)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 10/590,582

(22) PCT Filed: Mar. 5, 2004
(86) PCT No.: PCT/US04/06796

§ 371 Date: Aug. 24, 2006

(51) Int. Cl. H04N 7/14

(52) U.S. Cl. 348/14.13

(57) ABSTRACT

There is provided an apparatus for compressing media content in an electronic device having a video capture device for capturing the video content. The apparatus includes a real-time, Low Complexity (LC) video compressor for compressing the video content into an LC encoded bit stream in real-time. The apparatus further includes a non-real-time High Complexity (HC) video compressor for generating an HC encoded bit stream from the LC encoded bit stream in non-real-time.

### BACKGROUND OF THE INVENTION

1. Field of the Invention

The present invention generally relates to multimedia and, more particularly, to a multi-stage media compression method and apparatus for mobile and other devices. The multi-stage media compression method and apparatus provide power and storage efficiency for the mobile and other devices.

2. Background of the Invention

Current mobile devices, such as cell phones and Personal Digital Assistants, have very strict power requirements in order to maximize battery life. Therefore, the mobile devices are designed with CPUs that have low power and, consequently, low processing power.

A future application that is desired for these devices is to be able to capture video with an embedded camera and encode (compress) the video data for efficient transmission through cellular networks. However, there are many difficult design issues for such a system. For example, the available network bandwidth in cellular networks is extremely limited and expensive. Therefore, a very high compression ratio is desired. Moreover, typical CPUs (even high end CPUs for PDAs) are not capable of performing real-time encoding of video at high compression ratios. The required CPU Million Instruction Per Second (MIPS) is usually at least 5 times what is available. Further, the amount of available memory for storage of uncompressed video is very limited. For a typical PDA with 64 Mbytes of RAM, only 20 seconds of 320×240@30 fps video can be stored uncompressed.

Accordingly, some solutions have been attempted to correct the above problems, but with only limited success, if any. For example, the brute force approach to solve this problem is to put in a CPU or other electronic circuit that encodes the video at high compression ratios in real time. However, this is an expensive solution in terms of the product cost and the battery life.

An alternative would be to store uncompressed video and encode at a later time in non-real time. However, the amount of memory available would only allow a very limited video capture period (e.g., 20 seconds for 320×240@30 fps or 70 seconds for a ¼ of the preceding resolution).

Yet another alternative would be to greatly reduce the video frame rate or the video resolution. However, this compromises the video quality at least 3-4 times, which results in a less than pleasing video entertainment experience.

Accordingly, it would be desirable and highly advantageous to have a media compression method and apparatus for mobile and other devices that overcomes the above-identified problems of the prior art.

### SUMMARY OF THE INVENTION

The problems stated above, as well as other related problems of the prior art, are solved by the present invention, which is directed to a media compression method and apparatus for mobile and other devices. The present invention solves these problems by implementing a real time Low Complexity (LC) encoded bit stream media compression step before a non-real time High Complexity (HC) encoded bit stream media encoding step. Advantageously, the present invention provides power and storage efficiency for the mobile and other devices.

According to an aspect of the present invention, there is provided an apparatus for compressing media content in an electronic device having a video capture device for capturing the video content. The apparatus includes a real-time, Low Complexity (LC) video compressor for compressing the video content into an LC encoded bit stream in real-time. The apparatus further includes a non-real-time High Complexity (HC) video compressor for generating an HC encoded bit stream from the LC encoded bit stream in non-real-time.

According to another aspect of the present invention, there is provided a method for compressing media content in an electronic device having a video capture device for capturing the video content. The method includes the step of compressing, in real-time, the video content into a Low Complexity (LC) encoded bit stream. The method further includes the step of generating, in non-real-time, a High Complexity (HC) encoded bit stream from the LC encoded bit stream.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 is a block diagram illustrating an apparatus 100 for compressing media in a mobile or other device, according to an illustrative embodiment of the present invention;

FIG. 2 is a flow diagram illustrating a method of media compression for a mobile or other device, according to an illustrative embodiment of the present invention;

FIG. 3 is a diagram illustrating a Low Complexity (LC) encoded bit stream 310 and a High Complexity (HC) encoded bit stream 320 for Intra frame re-use in HC encoding, according to an illustrative embodiment of the present invention; and

FIG. 4 is a diagram illustrating a mobile device 400 in accordance with an illustrative embodiment of the present invention.

### DETAILED DESCRIPTION OF THE INVENTION

The present invention is directed to a media compression method and apparatus for mobile and other devices. The present invention provides power and storage efficiency for the mobile and other devices. The present invention may be implemented with respect to mobile device including, but not limited to, cellular telephones (hereinafter “cell phones), Personal Digital Assistants (PDAs), camcorders, and digital cameras, and so forth. The present invention may also be implemented with respect to non-mobile devices including, but not limited to, Personal Video Recorders (PVRs), and so forth. Moreover, the present invention may be implemented with respect to video and/or audio media.

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof) that is executed via the operating system. In addition, various other peripheral devices may be connected to the computer platform such as an additional data storage device and a printing device.

It is to be further understood that, because some of the constituent system components and method steps depicted in the accompanying Figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

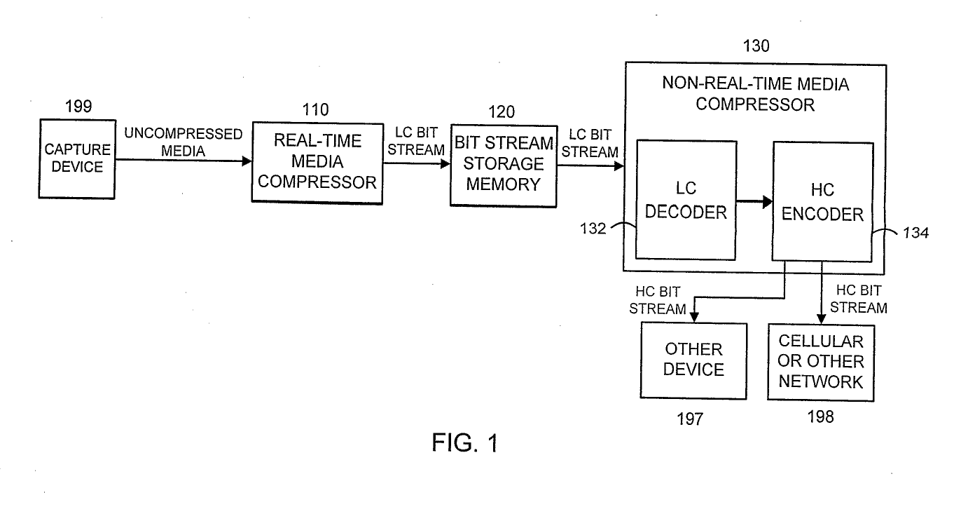

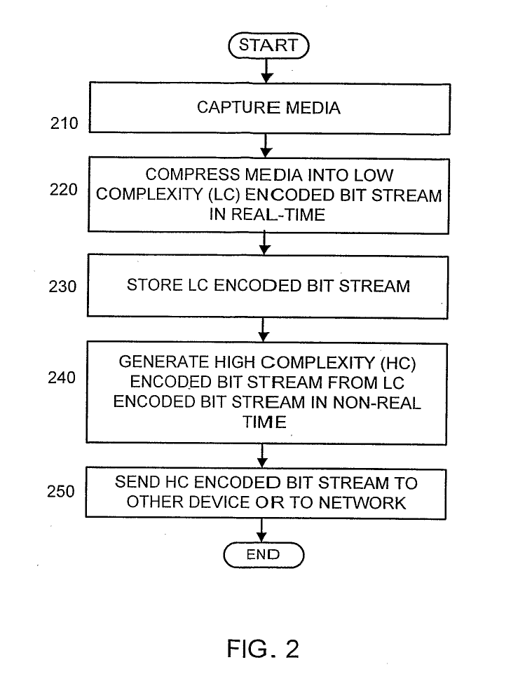

FIG. 1 is a block diagram illustrating an apparatus 100 for compressing media in a mobile or other device, according to an illustrative embodiment of the present invention. FIG. 2 is a flow diagram illustrating a method of media compression for a mobile or other device, according to an illustrative embodiment of the present invention. It is to be appreciated that the media may include video and/or audio content.

The apparatus 100 includes a real-time media compressor 110, a memory device 120, and a non-real-time media compressor 130. The non-real-time media compressor 130 includes a Low Complexity (LC) decoder 132 and a High Complexity (HC) encoder 134. The real-time media compressor 110 employs a low compression ratio and low CPU complexity in compressing media in comparison to the non-real-time media compressor 130, which employs a high compression ratio and high CPU complexity. It is to be appreciated that in some embodiments of the present invention, the LC encoder 132 and the HC encoder 134 are implemented on a same processor device.

Media is captured by a capture device 199 (step 210). The media may include video and/or audio content. In the case of video content, the capture device 199 may be, e.g., a camera or image sensor together with an Analog-to-Digital Converter (ADC), or some other type of video capture device. In the case of audio content, the capture device may be a microphone together with an ADC, or some other type of audio capture device.

The uncompressed media is forwarded to the real-time media compressor 110 and is compressed into a Low Complexity (LC) encoded bit stream by the real-time media compressor 110 (step 220). The real-time media compressor 110 can be considered an intermediate encoder that operates in real-time and performs compression on the incoming bit stream. The compression implemented by the real-time media compressor 110 is preferably on the order of 20:1 or greater.

The LC encoded bit stream is forward to, and stored by, the memory device 120 (step 230). Preferably, the memory device 120 is a local memory device such as a Random Access Memory (RAM), a memory storage card (e.g., FLASH or MICRODRIVE), etc.

Depending on the CPU capability and architecture, the next step of high compression efficiency encoding can begin while the media is still being captured by the capture device 199 or when capturing is complete. An HC encoded bit stream is generated from the LC encoded bit stream by the non-real-time media compressor 130 (step 240). Once the HC encoded bit stream is complete or while still being encoded, the mobile or other device can send the stream to some other device 197 or to the network 198 (step 250), which may be a cellular or other type of network. Of course, if the HC encoded bit stream is sent to the network, it is likely that the HC encoded bit stream will be sent to some device within the network 197.

A description will now be given of methods of LC and HC video compression, according to an illustrative embodiment of the present invention. It is to be appreciated that the present invention is not limited to the methods of LC and HC video compression described herein, and any other methods for LC and HC video compression may be utilized by the present invention while maintaining the spirit thereof. Moreover, as noted above and described in further detail herein below, the present invention may also be applied to audio media and is similarly not limited to the methods of LC and HC audio compression described herein, and any other methods for LC and HC audio compression may be utilized by the present invention while maintaining the spirit thereof.

The LC and HC formats can be defined by any given application. The goal is that the LC compression is relatively low in complexity compared to the HC compression, such that the LC compression can run in real-time on a large variety of CPUs for a given application such as, for example, a digital camcorder. The LC compression must be sufficient enough that a high level of compression is performed (typically, the desired compression level is 20:1), such that a significant length of content can be saved on a small storage device. Each application has its own platform constraints of hardware and CPU capability and storage size availability.

For the HC format, typically the best compression possible should be considered, as long as the real-time decoders can be utilized for the end device for which the HC bitstream is targeted.

For HC generation, the Motion Picture Experts Group 4 (MPEG4)-part 10 (also known as “Joint Video Team (JVT) or (H.264)) encoding method is preferred. MPEG4-part 10 currently has the highest encoding efficiency of any known method. MPEG4-part 10 is capable of 184:1 compression ratios (approximately 2-3 times as efficient as MPEG2).

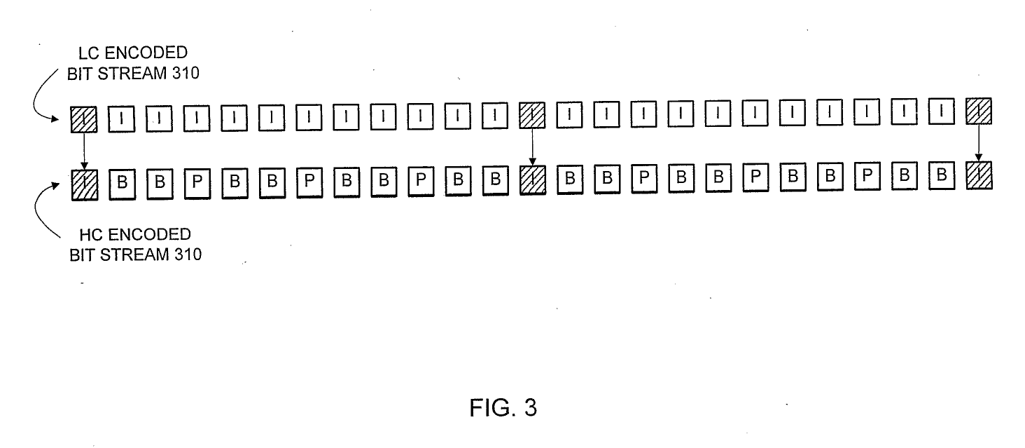

MPEG4-part 10 uses Intra (I), forward Predictive (P), and Bi-directionally predictive (B) frame types. Intra frames are the least efficient and P and B are much more efficient. Thus, to reduce HC encoding time, it is preferably to use MPEG4-part 10 Intra frames for the LC compression. That is, the LC encoder produces MPEG4-part 10 Intra frame only sequences at a compression efficiency ratio of approximately 20:1. Then, the HC encoder can re-use the Intra frames it needs and replace some number (any number) of the other Intra Frames. FIG. 3 is a diagram illustrating a Low Complexity (LC) encoded bit stream 310 and a High Complexity (HC) encoded bit stream 320 for Intra frame re-use in HC encoding, according to an illustrative embodiment of the present invention. The LC encoded bit stream 310 includes only Intra (I) frame types, while the HC encoded bit stream 320 includes Intra, forward predictive (P), and bi-directionally predictive (B) frame types.

The HC encoder 134 would have to decode all LC Intra frames since uncompressed reference frames are used in encoding P and B frames. However, the extra step of encoding the Intra frames of the HC bit stream would not have to be done.

As an example of the advantages of such a system, consider a PDA with 64 MB of RAM. With a 20:1 compression ratio, approximately 26 minutes of LC encoded bit stream could be stored (presuming 320×240@30 fps). A typical use in the application is to store short video segments such as a video message that includes the sender talking and/or the scenery in the local area. Given that a HC encode might take 5× of real time, then the person could take 5 minutes of video and then the HC encoded stream would be complete 25 minutes later. Of course, the user could also take 26 minutes of an LC encoded bit stream, but then would have to wait 2 hours before the HC encoded stream was complete. This model supports taking 26 minutes of video on average every 2 hours. Typical consumer usage of handheld video recorders involves taking no more than several minutes of content at a time.

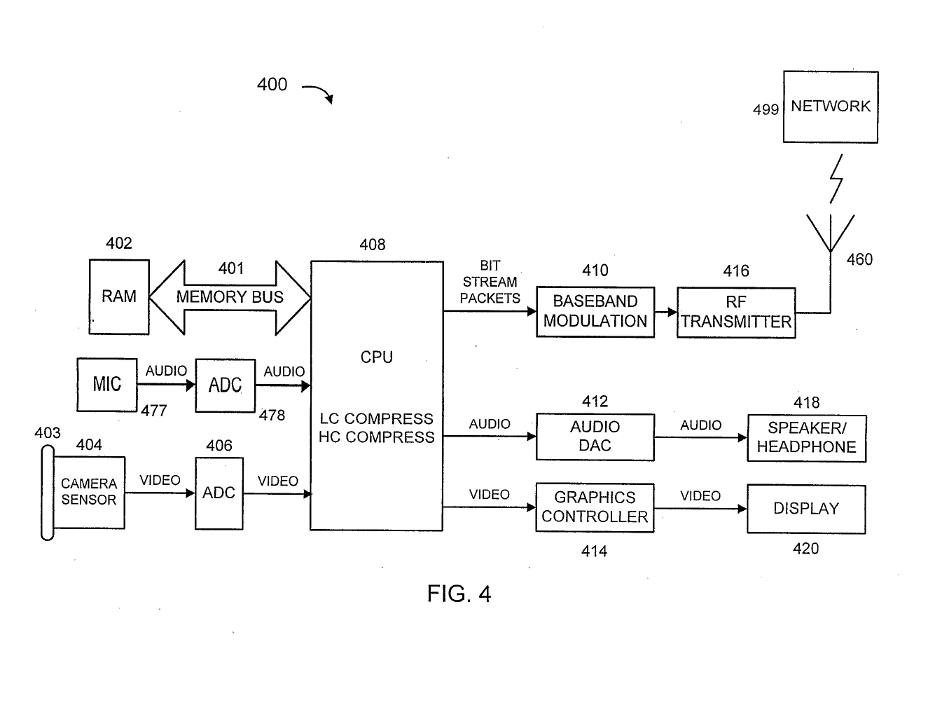

FIG. 4 is a diagram illustrating a mobile device 400 in accordance with an illustrative embodiment of the present invention. The mobile device 400 includes a memory bus 401, a Random Access Memory (RAM) 402, a camera sensor 404 having a lens 403, an Analog-to-Digital Converter 406 (ADC), a CPU 408, a baseband modulation module 410, an audio Digital-to-Analog Converter (DAC) 412, a graphics controller 414, a Radio Frequency (RF) transmitter 416, a speaker/headphone 418, a display 420 (e.g., a Liquid Crystal Display (LCD) or some other type of display), an antenna 460, a microphone 477, and an Analog-to-Digital Converter (ADC) 478. The mobile device 400 communicates with a cellular network 499.

Video is captured from the camera sensor 404 (e.g., Charge Coupled Device (CCD), Complimentary Metal Oxide Semiconductor (CMOS), and so forth), digitized and delivered to the CPU 408. The CPU 408 performs an LC compression operation so as to LC compress the captured video in real time and place the LC encoded bit stream in the RAM 402. When the CPU 408 has MIPS available for HC encoding, then the CPU 408 can perform the HC compression and remove the LC encoded stream from the RAM 402 to free memory space. This HC encoded stream can then be sent through any network including low bandwidth networks such as cellular network 499.

In an alternative embodiment of the invention, a different LC compression could be used such as motion JPEG, which is widely supported in mobile devices and even in camera sensor Integrated Circuits (ICs) as a post process. In this way, the CPU could be dedicated for HC compression since the MJPEG encoding is external to the CPU.

A brief description will now be given of some of the many advantages of the present invention. The present invention can be applied to any mobile device architecture capable of at least LC real time encoding. From the smallest cell phone to the most advanced PDA. Moreover, HC real time encoding hardware is not required and, therefore, saves on hardware costs in the device as well as power usage. Further, the optimum use of the low bandwidth channel is achieved since HC compression is the most efficient. Also, by using an intermediate LC compression, 20 times the amount of video can be captured by the consumer. This allows many minutes of video instead of just a few seconds and meets the typical usage of a camcorder consumer.

A description will now be given of other applications and devices to which the present invention may be applied while maintaining the spirit of the present invention. Such application includes, but are not limited to, Personal Video Recorders (PVRs), camcorders/digital cameras/and audio applications. It is to be appreciated that given the teachings of the present invention provided herein, one of ordinary skill in the related art will contemplate these and various other devices, applications, and implementations to which the present invention may be applied while maintaining the spirit of the present invention.

With respect to PVRs, it is desirable for the content to be encoded in the most efficient manner. However, the content must be captured in real-time for immediate playback and simultaneous storage on the HDD (hard disk drive). An LC compression can be used for this immediate real-time requirement and then, at a later time, the LC encoded stream can be re-encoded (as described herein) with HC non-real-time compression. This could take place whenever the PVR is not in active use, or perhaps during the night time hours.

The advantage for the PVR is that once an HC encoding is complete, then the LC encoded version can be removed and, due to the higher bit rate efficiency of the HC stream, more HDD space available is then available.

With respect to camcorders and digital cameras, more content can be stored on such devices by using the HC non-real-time encoding after LC encoding in real time capture mode. Since Camcorder use is generally in short bursts that last, on average, up to 5 minutes, the LC to HC conversion could take place very easily.

The advantage would be to have a lower complexity and lower cost camcorder with a higher capacity. In the case where the camcorder is connected to a network device of any kind, the HC compression allows the video signal to be distributed faster and with less bandwidth. Many camcorders use Digital Video (DV) compression, which is an LC type of Intra frame compression similar to MPEG2 Intra frames. This could still be used in DV camcorders for the LC format, but with the HC format being JVT or some other format such as, for example, MPEG2.

With respect to audio applications, the present invention may also be applied thereto. For example, an audio recorder (e.g., in a camcorder, PDA, and so forth) could use an LC encoding for real-time, and then a HC encoding for optimizing storage and transmission. As an example, Moving Picture Experts Group Layer-3 Audio (MP3) could be used for LC encoding and MP3 Pro could be used for HC encoding.

Although the illustrative embodiments have been described herein with reference to the accompanying drawings, it is to be understood that the present invention is not limited to those precise embodiments, and that various other changes and modifications may be affected therein by one of ordinary skill in the related art without departing from the scope or spirit of the invention. All such changes and modifications are intended to be included within the scope of the invention as defined by the appended claims.

1. An apparatus for compressing media content in an electronic device having a video capture device for capturing the video content, comprising:
a real-time, Low Complexity (LC) video compressor for compressing the video content into an LC encoded bit stream in real-time; and
a non-real-time High Complexity (HC) video compressor for generating an HC encoded bit stream from the LC encoded bit stream in non-real-time.

2. The apparatus of claim 1, further comprising a memory device for storing the LC encoded bit stream therein.

3. The apparatus of claim 1, wherein said non-real-time HC video compressor begins generating the HC encoded bit stream while the video capture device is still capturing the video content and the real-time LC video compressor is still compressing the video content.

4. The apparatus of claim 1, wherein the electronic device is a mobile type of device, being one of a cellular telephone, a Personal Digital Assistant (PDA), a digital camera, and a camcorder.

5. The apparatus of claim 1, wherein the electronic device is a Personal Video Recorder (PVR), and said real-time LC video compressor compresses the video content into the LC encoded bit stream in real-time so as to meet any real-time requirements of the video content, while said non-real-time HC video compressor generates the HC encoded bit stream from the LC encoded bit stream in non-real-time so as to reduce storage requirements of the underlying video content.

6. The apparatus of claim 1, wherein said non-real-time HC video compressor is capable of reusing at least a portion of the LC encoded bit stream so as to avoid having to again encode the at least a portion of the LC encoded bit stream to generate the HC encoded bit stream.

7. The apparatus of claim 1, wherein said real-time LC video compressor compresses the video content into Intra (I) frame types of Motion Picture Experts Group 4-part 10.

8. The apparatus of claim 7, wherein said non-real-time HC video compressor generates the HC encoded bit stream as I, forward Predictive (P), and Bi-predictive (B) frame types of the Motion Picture Experts Group 4-part 10.

9. The apparatus of claim 8, wherein said non-real-time HC video compressor is capable of reusing the I frame types of the LC encoded bit stream so as to avoid having to again encode the I frame types of the LC encoded bit stream to generate the HC encoded bit stream.

10. The apparatus of claim 1, wherein said non-real-time HC video compressor generates the HC encoded bit stream from the LC encoded bit stream so as to minimize bandwidth consumption in a transmission of the HC encoded bit stream from the electronic device in comparison to a transmission of the LC encoded bit stream.

11. The apparatus of claim 1, wherein said real-time, LC video compressor compresses the video content into the LC encoded bit stream so as to increase an amount of the video content that can be immediately stored subsequent to capture.

12. The apparatus of claim 1, wherein said electronic device is further capable of capturing audio content, and said apparatus further comprises:
a real-time LC audio compressor for compressing the audio content into another LC encoded bit stream that corresponds to the audio content; and
a non-real-time HC audio compressor for generating another HC encoded bit stream from the other LC encoded bit stream corresponding to the audio content.

13. The apparatus of claim 12, wherein said real-time LC audio compressor compresses the audio content using Moving Picture Experts Group Layer-3 Audio (MP3), and said non-real-time audio compressor generates the other HC encoded bit stream from the other LC encoded bit stream using MP3-Pro.

14. A method for compressing media content in an electronic device having a video capture device for capturing the video content, comprising the steps of:
compressing, in real-time, the video content into an Low Complexity (LC) encoded bit stream; and
generating, in non-real-time, an HC encoded bit stream from the LC encoded bit stream.

15. The method of claim 14, wherein said generating step begins generating the HC encoded bit stream while the video capture device is still capturing the video content and the video content is still being compressed into the LC encoded bit stream.

16. The method of claim 14, wherein the electronic device is a mobile type of device, being one of a cellular telephone, a Personal Digital Assistant (PDA), a digital camera, and a camcorder.

17. The method of claim 14, wherein the electronic device is a Personal Video Recorder (PVR), and said compressing step compresses the video content into the LC encoded bit stream in real-time so as to meet any real-time requirements of the video content while said generating step generates the HC encoded bit stream from the LC encoded bit stream in non-real-time so as to reduce storage requirements of the underlying video content.

18. The method of claim 14, wherein said generating step is capable of reusing at least a portion of the LC encoded bit stream so as to avoid having to again encode the at least a portion of the LC encoded bit stream to generate the HC encoded bit stream.

19. The method of claim 14, wherein said compressing step compresses the video content into Intra (I) frame types of Motion Picture Experts Group 4-part 10.

20. The method of claim 19, wherein said generating step generates the HC encoded bit stream as I, forward Predictive (P), and Bi-predictive (B) frame types of the Motion Picture Experts Group 4-part 10.

21. The method of claim 20, wherein said generating step is capable of reusing the I frame types of the LC encoded bit stream so as to avoid having to again encode the I frame types of the LC encoded bit stream to generate the HC encoded bit stream.

22. The method of claim 14, wherein said generating step generates the HC encoded bit stream from the LC encoded bit stream so as to minimize bandwidth consumption in a transmission of the HC encoded bit stream from the electronic device in comparison to a transmission of the LC encoded bit stream.

23. The method of claim 14, wherein said compressing step compresses the video content into the LC encoded bit stream so as to increase an amount of the video content that can be immediately stored subsequent to capture.

24. The method of claim 14, wherein said electronic device is further capable of capturing audio content, and said method further comprises the steps of:
compressing the audio content into another LC encoded bit stream that corresponds to the audio content; and
generating another HC encoded bit stream from the other LC encoded bit stream corresponding to the audio content.

25. The method of claim 24, wherein said step of compressing the audio content compresses the audio content using Moving Picture Experts Group Layer-3 Audio (MP3), and said step of generating another HC encoded bit stream generates the HC encoded bit stream from the LC encoded bit stream using MP3-Pro.
